(19) United States
(12) Patent Application Publication
(10) Pub. No.: US 2025/0300321 A1
(43) Pub. Date: Sep. 25, 2025

(54) BATTERY

(71) Applicant: TOYOTA JIDOSHA KABUSHIKI KAISHA, Toyota-shi (JP)

(72) Inventors: Isamu HAYAKAWA, Okazaki-shi (JP); Takayuki HIROSE, Kariya-shi (JP); Tomohiro NAKAMURA, Kariya-shi (JP)

(73) Assignee: TOYOTA JIDOSHA KABUSHIKI KAISHA, Toyota-shi (JP)

(21) Appl. No.: 19/051,255

(22) Filed: Feb. 12, 2025

(30) Foreign Application Priority Data
Mar. 25, 2024 (JP) 2024-048732

(51) Int. Cl. H01M 50/489; H01M 4/02; H01M 10/04

(52) U.S. Cl. CPC H01M 50/489; H01M 10/0486; H01M 2004/029

(57) ABSTRACT

A battery includes: an electrode assembly in which a current collector foil, a positive electrode active material layer, and a negative electrode active material layer are stacked, and the current collector foil includes an uncoated portion not coated with the positive electrode active material layer and the negative electrode active material layer in a stacking direction; a first sealing member having a quadrilateral frame shape, the first sealing member being disposed so as to cover a region of the uncoated portion on an end side of the current collector foil; and a second sealing member having a quadrilateral frame shape, the second sealing member being disposed so as to cover an outer surface of the first sealing member. The second sealing member is configured of a material having a linear thermal expansion coefficient of 40×10⁻⁶/° C. or less in at least a region of a corner portion.

### CROSS-REFERENCE TO RELATED APPLICATION

This application claims priority to Japanese Patent Application No. 2024-048732 filed on Mar. 25, 2024, incorporated herein by reference in its entirety.

### BACKGROUND

### 1. Technical Field

The present disclosure relates to a battery.

### 2. Description of Related Art

Hitherto, there has been used a battery including: an electrode assembly in which a current collector foil, a positive electrode active material layer, and a negative electrode active material layer are stacked; a first sealing member disposed so as to cover a region of an uncoated portion on an end side of the current collector foil; and a second sealing member disposed so as to cover an outer surface of the first sealing member.

For example, Japanese Unexamined Patent Application Publication No. 2021-174632 (JP 2021-174632 A) discloses an electricity storage module including: an electrode stack including a plurality of stacked metal plates; and a sealing member provided for sealing an internal space formed between two metal plates adjacent to each other out of the metal plates. The sealing member includes first sealing portions each having a rectangular annular shape and being joined to peripheral edge portions of the metal plates, and a second sealing portion provided around the stacked first sealing portions. The second sealing portion includes a first resin portion provided around the first sealing portions, and a second resin portion provided around the first resin portion. A difference between the linear thermal expansion coefficient of the first sealing portion and the linear thermal expansion coefficient of the first resin portion is smaller than a difference between the linear thermal expansion coefficient of the first sealing portion and the linear thermal expansion coefficient of the second resin portion.

Further, Japanese Unexamined Patent Application Publication No. 2019-091606 (JP 2019-091606 A) discloses a method of manufacturing a bipolar battery including: a first step of producing a battery structure including an electrode stacking portion and a primary seal portion; a second step of injecting an electrolyte into the battery structure from injection holes of the primary seal portion in a state in which the electrode stacking portion is restrained by a pair of restraining plates such that a distance between the restraining plates sandwiching the electrode stacking portion in a stacking direction becomes a defined length; a third step of discharging the electrolyte from the injection holes by restraining the electrode stacking portion by the restraining plates such that the distance between the restraining plates becomes shorter than the defined length; and a fourth step of restraining, after the third step is carried out, the electrode stacking portion by the restraining plates such that the distance between the restraining plates becomes the defined length.

### SUMMARY

However, in the battery of the related art, resin is generally used for the second sealing member disposed so as to cover the outer surface of the first sealing member. The second sealing member configured of resin easily expands and contracts due to temperature change. Under a low temperature environment, the second sealing member sometimes contracts to cause a force in a contracting direction to act on a corner portion of the second sealing member. When the force in the contracting direction described above acts on the corner portion of the second sealing member, a stress is applied to a corner portion of the uncoated portion of the current collector foil, and this stress may cause wrinkles in the uncoated portion of the current collector foil.

The present disclosure has been made in view of the above-mentioned circumstances, and has an object to provide a battery that is reduced in generation of wrinkles in an uncoated portion of a current collector foil.

Means for solving the above-mentioned problem includes the following aspects.

<1> A battery including:
an electrode assembly in which a current collector foil, a positive electrode active material layer, and a negative electrode active material layer are stacked, and the current collector foil includes an uncoated portion not coated with the positive electrode active material layer and the negative electrode active material layer in a stacking direction;
a first sealing member having a quadrilateral frame shape, the first sealing member being disposed so as to cover a region of the uncoated portion on an end side of the current collector foil; and
a second sealing member having a quadrilateral frame shape, the second sealing member being disposed so as to cover an outer surface of the first sealing member, in which
the second sealing member is configured of a material having a linear thermal expansion coefficient of 40×10⁻⁶/° C. or less in at least a region of a corner portion.

<2> The battery according to <1>, in which the second sealing member is entirely configured of the material having the linear thermal expansion coefficient of 40×10⁻⁶/° C. or less.

<3> The battery according to <1> or <2>, in which the first sealing member is configured of a material having a linear thermal expansion coefficient of 40×10⁻⁶/° C. or less in at least a region of a corner portion.

<4> The battery according to <3>, in which the first sealing member is entirely configured of the material having the linear thermal expansion coefficient of 40×10⁻⁶/° C. or less.

<5> The battery according to any one of <1> to <4>, in which the material having the linear thermal expansion coefficient of 40×10⁻⁶/° C. or less is at least one type selected from the group consisting of glass epoxy resin, Lossna-Board, Miolex, Besthermo, polybutylene terephthalate, polyether ether ketone, polyamide imide, alumina, zirconia, forsterite, steatite, mullite, aluminum nitride, zircon, zircon cordierite, cordierite, low expansion cordierite, aluminum titanate, β-spodumene, and standard porcelain.

According to the present disclosure, the battery that is reduced in generation of wrinkles in the uncoated portion of the current collector foil is provided.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic sectional view illustrating a structure of a bipolar-type secondary battery according to an embodiment of the present disclosure; and

FIG. 2 is a schematic plan view illustrating the vicinity of corner portions of a current collector foil, a first sealing member, and a second sealing member in a battery of the related art.

### DETAILED DESCRIPTION OF EMBODIMENTS

### Battery

A battery according to an embodiment of the present disclosure includes an electrode assembly in which a current collector foil, a positive electrode active material layer, and a negative electrode active material layer are stacked, a first sealing member, and a second sealing member.

The current collector foil of the electrode assembly includes an uncoated portion not coated with the positive electrode active material layer and the negative electrode active material layer in a stacking direction.

The first sealing member is disposed so as to cover a region of the uncoated portion on an end side of the current collector foil. The first sealing member has a quadrilateral frame shape.

The second sealing member is disposed so as to cover an outer surface of the first sealing member. The second sealing member has a quadrilateral frame shape.

In addition, the second sealing member is configured of a material having a linear thermal expansion coefficient of 40×10⁻⁶/° C. or less in a region of a corner portion (hereinafter simply referred to as “corner portion region”).

It is to be noted that, in the present disclosure, “the region of the corner portion” in the second sealing member refers to a region up to 1/10 of a length of one side from, as a starting point, a corner of the second sealing member having a quadrilateral shape. Similarly, “the region of the corner portion” in the first sealing member also refers to a region up to 1/10 of a length of one side from, as a starting point, a corner of the first sealing member having a quadrilateral shape. Each of the first sealing member and the second sealing member having a quadrilateral shape includes four corners, and has four corner portion regions from the corners serving as starting points.

The battery includes, for example, a negative electrode, a positive electrode, a separator, and an electrolyte. The battery according to the embodiment of the present disclosure is suitably used for, for example, a liquid battery including a liquid electrolyte. A liquid battery including a non-aqueous electrolyte is particularly preferred. Further, a bipolar-type battery including a positive electrode active material layer and a negative electrode active material layer on both surfaces of a current collector having functions of a positive electrode current collector and a negative electrode current collector may be employed.

Hereinafter, the battery according to the embodiment of the present disclosure is described in detail with reference to the drawings. Here, the configuration of the battery according to the embodiment of the present disclosure is described by means of a bipolar-type secondary battery as an example.

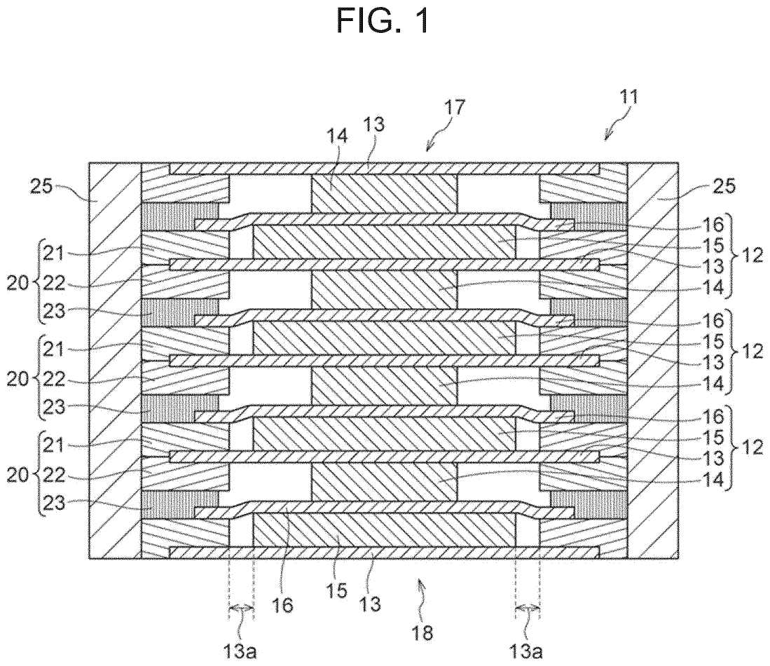

It is to be noted that, in FIG. 1, the term “upper surface” means an upper side of the drawing, and the term “lower surface” means a lower side of the drawing. FIG. 1 is a schematic sectional view illustrating the structure of the bipolar-type secondary battery, and illustrates one electricity storage module 11 in the secondary battery. The secondary battery is configured to include a stack in which a plurality of the electricity storage modules 11 and a plurality of electrically conductive plates (not illustrated) are alternately disposed.

The electricity storage module 11 is a quadrilateral flat-plate cell as a whole, and the electricity storage module 11 of this embodiment is a bipolar-type lithium ion secondary battery. The electricity storage module 11 includes an electrode stack obtained by stacking a plurality of bipolar electrodes 12, a plurality of first sealing members 20 included in the respective bipolar electrodes 12, and a second sealing member 25 included so as to cover outer surfaces of the first sealing members 20 (that is, surfaces of the first sealing members 20 on a side opposite to the electrode stack). The bipolar electrodes 12 are stacked along a thickness direction (thickness direction in the flat-plate shape), and the first sealing member 20 is disposed for each of the bipolar electrodes 12. On the first sealing members 20, the second sealing member 25 is disposed so as to cover the outer surfaces of the first sealing members 20.

Each of the bipolar electrodes 12 includes a current collector foil 13, a positive electrode active material layer 14 provided on the lower surface of the current collector foil 13, a negative electrode active material layer 15 provided on the upper surface of the current collector foil 13, and a separator 16. The current collector foil 13 is a foil-shaped electrically conductive member having a quadrilateral shape in plan view, and the current collector foil 13 is a laminated foil obtained by stacking a plurality of metal foils of different types. Examples of the current collector foil 13 include a laminated foil of an aluminum foil and a copper foil. The current collector foil 13 includes an uncoated portion 13a not coated with the positive electrode active material layer 14 and the negative electrode active material layer 15 in the stacking direction.

The positive electrode active material layer 14 configures the positive electrode of the bipolar electrode 12, and is disposed on the lower surface of the current collector foil 13 via an adhesive layer. The positive electrode active material layer 14 includes a positive electrode active material, and can further include an electrical conduction aid, a binding agent, and the like.

Examples of the positive electrode active material include a composite oxide, metallic lithium, and sulfur. The composition of the composite oxide includes, for example, at least one of iron, manganese, titanium, nickel, cobalt, and aluminum, and lithium. Examples of the composite oxide include olivine-type lithium iron phosphate (LiFePO₄), LiCoO₂, and LiNiMnCoO₂. Examples of the binding agent include fluorine-containing resins such as polyvinylidene fluoride, polytetrafluoroethylene, and fluororubber, thermoplastic resins such as polypropylene and polyethylene, imide-based resins such as polyimide and polyamide imide, an alkoxysilyl group-containing resin, an acrylic resin including a monomer unit such as an acrylic acid and a methacrylic acid, styrene-butadiene rubber (SBR), carboxymethyl cellulose, alginates such as a sodium alginate and an ammonium alginate, a water-soluble cellulose ester crosslinked product, and starch-acrylic acid graft polymer. These binding agents may be used singly or in plurality. Examples of the electrical conduction aid include acetylene black, carbon black, and graphite.

The negative electrode active material layer 15 configures the negative electrode of the bipolar electrode 12, and is disposed on the upper surface of the current collector foil 13.

The negative electrode active material layer 15 can include a negative electrode active material, an electrical conduction aid, and a binding agent. The electrical conduction aid and the binding agent exemplified for the positive electrode active material layer 14 may be used therefor. Examples of the negative electrode active material include graphite, artificial graphite, highly oriented graphite, mesocarbon microbeads, carbon such as hard carbon and soft carbon, a metal compound, an element that can alloy with lithium or a compound of the element, and boron-doped carbon. Examples of the element that can alloy with lithium include silicon (Si) and tin.

The separator 16 is, for example, a porous sheet or non-woven fabric including polymer that absorbs and holds the electrolyte, and is disposed on the upper surface of the negative electrode active material layer 15.

In order to form the positive electrode active material layer 14 and the negative electrode active material layer 15 on the current collector foil 13, for example, publicly known methods such as a roll coat method, a die coat method, a dip coat method, a doctor blade method, a spray coat method, and a curtain coat method are used. Specifically, a slurry is produced by mixing an active material, a solvent, and a binding agent and an electrical conduction aid as required, and the slurry is applied to the upper surface and the lower surface of the current collector foil 13 and is then dried. It is to be noted that, when the positive electrode active material layer 14 and the negative electrode active material layer 15 are formed on the current collector foil 13, slurries of the positive electrode active material layer and the negative electrode active material layer are applied so as to form the uncoated portion 13a.

In the electrode stack, the bipolar electrodes 12 adjacent to each other in the stacking direction are stacked to cause the positive electrode active material layer 14 of one bipolar electrode 12 to overlap the separator 16 of the other bipolar electrode 12. In addition, the electrode stack includes, at end portions in the stacking direction of the stack including the bipolar electrodes 12, a positive electrode terminal electrode 17 at its upper end and a negative electrode terminal electrode 18 at its lower end. The positive electrode terminal electrode 17 includes a current collector foil 13 and a positive electrode active material layer 14 provided on the lower surface of the current collector foil 13. The positive electrode active material layer 14 is stacked on the adjacent bipolar electrode 12, and the current collector foil 13 is stacked on the upper surface thereof. The negative electrode terminal electrode 18 includes a current collector foil 13, a negative electrode active material layer 15 provided on the upper surface of the current collector foil 13, and a separator 16 stacked on the upper surface thereof. The separator 16 is stacked on the adjacent bipolar electrode 12, and the negative electrode active material layer 15 is stacked on the lower surface thereof and the current collector foil 13 is further stacked on the lower surface thereof. The positive electrode terminal electrode 17 and the negative electrode terminal electrode 18 are each stacked on an electrically conductive plate to which the current collector foil 13 is adjacent.

Each of the first sealing members 20 is a quadrilateral and frame-shaped member, and is disposed on an outer peripheral end portion of the bipolar electrode 12. The first sealing member 20 is a member that seals the bipolar electrode 12. Thus, a space between the bipolar electrodes 12 adjacent to each other in the stacking direction is also sealed. The first sealing member 20 includes a first seal member 21, a second seal member 22, and a spacer 23.

The first seal member 21 is a quadrilateral and frame-shaped member, and is disposed along the outer peripheral end portion (outer edge) of the bipolar electrode 12. Specifically, the first seal member 21 is disposed and joined between the upper surface of the current collector foil 13 and the lower surface of the separator 16 at the outer peripheral end portion of the bipolar electrode 12 so as to dispose the negative electrode active material layer 15 within the frame of the first seal member 21. A predetermined gap is provided between an inner edge of the first seal member 21 and the negative electrode active material layer 15 to form a space. Meanwhile, an outer edge of the first seal member 21 is configured such that the first seal member 21 protrudes to the outer side from the current collector foil 13.

The second seal member 22 is a quadrilateral and frame-shaped member, and is disposed along the outer peripheral end portion (outer edge) of the bipolar electrode 12. Specifically, the second seal member 22 is disposed and joined between the lower surface of the current collector foil 13 and the upper surface of the spacer 23 at the outer peripheral end portion of the bipolar electrode 12 so as to dispose together with the spacer 23 the positive electrode active material layer 14 within the frame of the second seal member 22. A predetermined gap is provided between an inner edge of the second seal member 22 and the positive electrode active material layer 14 to form a space. Meanwhile, an outer edge of the second seal member 22 is configured such that the second seal member 22 protrudes to the outer side from the current collector foil 13, and the upper surface of the second seal member 22 is joined to the lower surface of the first seal member 21. In this manner, the first seal member 21 and the second seal member 22 cover a region of the uncoated portion 13a on the end side of the current collector foil 13.

The spacer 23 is a quadrilateral and frame-shaped member, and is disposed along the outer peripheral end portion of the bipolar electrode 12. Specifically, the spacer 23 is combined with the second seal member 22 and is thus disposed and joined between the lower surface of the second seal member 22 and the upper surface of the separator 16 of the adjacent bipolar electrode 12 at the outer peripheral end portion of the bipolar electrode 12 so as to dispose the positive electrode active material layer 14 within the frame of the spacer 23. An inner edge of the spacer 23 is disposed so as to be spaced apart from the positive electrode active material layer 14. Meanwhile, an outer edge of the spacer 23 is configured such that the spacer 23 protrudes to the outer side from the separator 16, and the lower surface of the spacer 23 is joined to the upper surface of the first seal member 21 of the adjacent first sealing member 20.

The second sealing member 25 is a quadrilateral and frame-shaped member, and is disposed along the outer peripheral end portions of the first sealing members 20. The second sealing member 25 causes the first sealing members 20 and the bipolar electrodes 12 to be disposed within the frame of the second sealing member 25. An inner edge of the second sealing member 25 is disposed so as to cover outer surfaces of the first sealing members 20.

The second sealing member 25 is entirely configured of a material having a linear thermal expansion coefficient of 40×10⁻⁶/° C. or less (hereinafter also simply referred to as “low expansion material”). Further, the first seal member 21, the second seal member 22, and the spacer 23 configuring the first sealing member 20 are also entirely configured of a material having a linear thermal expansion coefficient of 40×10⁻⁶/° C. or less (low expansion material).

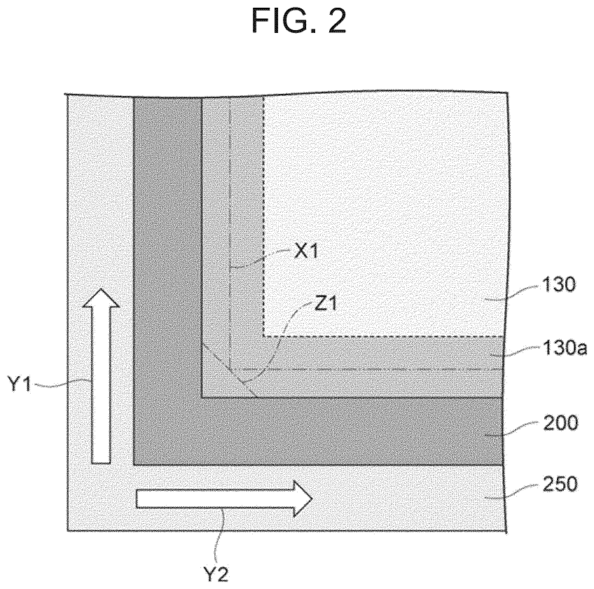

Here, the battery of the related art is described. FIG. 2 is a schematic plan view illustrating the vicinities of the corner portions of the current collector foil, the first sealing member, and the second sealing member in the battery of the related art.

In the battery of the related art, a quadrilateral and frame-shaped first sealing member 200 is disposed so as to cover a region of an uncoated portion 130a on an end side of a current collector foil 130, and further a quadrilateral and frame-shaped second sealing member 250 is disposed so as to cover an outer surface of the first sealing member 200. In addition, the second sealing member 250 is configured with the use of, for example, resin. Accordingly, as illustrated in FIG. 2, the second sealing member 250 easily expands and contracts due to temperature change. Under a low temperature environment, the second sealing member 250 may contract to cause forces in an arrow Y1 direction and an arrow Y2 direction to act on a corner portion of the second sealing member 250. When the forces in the arrow Y1 direction and the arrow Y2 direction act on the corner portion of the second sealing member 250, a stress is applied to a portion Z1 in a corner portion of the uncoated portion 130a of the current collector foil 130. As a result, wrinkles may be generated in the portion Z1 in the corner portion of the uncoated portion 130a of the current collector foil 130, and further generation of remarkable wrinkles may cause breakage.

It is to be noted that the battery is sometimes configured such that, in the stacking direction, no member other than the current collector foil 130 and the separator (not illustrated) is present in a region of the uncoated portion 130a of the current collector foil 130. In the battery having this configuration, the moment of inertia of area is decreased, and buckling (a phenomenon that deformation of great warpage occurs in the current collector foil 130) sometimes occurs in a portion X1 of the uncoated portion 130a due to the own weight of the current collector foil 130. In addition, in a case where the buckling occurs in the uncoated portion 130a of the current collector foil 130, when the wrinkles described above are further generated in the portion Z1, the combination of the buckling and the wrinkles causes the current collector foil 130 to be more easily broken.

In contrast, in the battery according to the embodiment of the present disclosure, the second sealing member is configured of the material having the linear thermal expansion coefficient of 40×10⁻⁶/° C. or less (low expansion material) in at least the corner portion region. Accordingly, the corner portion region of the second sealing member is prevented from expanding and contracting due to the temperature change. In this manner, even under a lower temperature environment, the forces in the arrow Y1 direction and the arrow Y2 direction illustrated in FIG. 2 are prevented from being generated in the corner portion region of the second sealing member. As a result, wrinkles are prevented from being generated in the corner portion of the uncoated portion of the current collector foil (specifically, the portion Z1 illustrated in FIG. 2), and further breakage is also prevented from occurring due to generation of remarkable wrinkles.

It is to be noted that the second sealing member 25 illustrated in FIG. 1 is entirely configured of the low expansion material, but the battery according to the embodiment of the present disclosure is not limited to this configuration. It is only required that at least the region of the corner portion (that is, the region up to 1/10 of the length of one side from the corner of the second sealing member serving as a starting point) be configured of the low expansion material. With the corner portion region of the second sealing member being configured of the low expansion material, even under the low temperature environment, the forces in the arrow Y1 direction and the arrow Y2 direction illustrated in FIG. 2 are prevented from being generated in the corner portion region of the second sealing member. As a result, wrinkles are prevented from being generated in the corner portion of the uncoated portion of the current collector foil, and further breakage is also prevented from occurring.

It is to be noted that, as illustrated in FIG. 1, the second sealing member 25 is preferably entirely configured of the low expansion material. With the second sealing member being entirely configured of the low expansion material, even under the low temperature environment, the forces in the corner portion region of the second sealing member (forces in the arrow Y1 direction and the arrow Y2 direction illustrated in FIG. 2) are prevented from being generated, and wrinkles are more easily prevented from being generated in the corner portion of the uncoated portion of the current collector foil.

Further, in the first sealing member (in FIG. 1, the first seal member 21, the second seal member 22, and the spacer 23 configuring the first sealing member 20), at least the region of the corner portion (that is, the region up to 1/10 of the length of one side from the corner of the first sealing member serving as a starting point) is preferably configured of the low expansion material. In the battery of the related art, resin is generally used also for the first sealing member. Thus, under the low temperature environment, the first sealing member may contract, and thus a stress may be applied to the corner portion of the uncoated portion of the current collector foil (specifically, the portion Z1 illustrated in FIG. 2). Accordingly, with the corner portion region of the first sealing member being configured of the low expansion material, even under the low temperature environment, the forces are prevented from being generated in the corner portion region of the first sealing member, and wrinkles are more easily prevented from being generated in the corner portion of the uncoated portion of the current collector foil.

Moreover, as illustrated in FIG. 1, the first sealing member 20 is preferably entirely configured of the low expansion material. With the first sealing member being entirely configured of the low expansion material, even under the low temperature environment, the forces in the corner portion region of the first sealing member (forces in the arrow Y1 direction and the arrow Y2 direction illustrated in FIG. 2) are prevented from being generated, and wrinkles are more easily prevented from being generated in the corner portion of the uncoated portion of the current collector foil.

As the material having the linear thermal expansion coefficient of 40×10⁻⁶/° C. or less (low expansion material), for example, there is given at least one type of material selected from the group consisting of glass epoxy resin, Lossna-Board, Miolex, Besthermo, polybutylene terephthalate, polyether ether ketone, polyamide imide, alumina, zirconia, forsterite, steatite, mullite, aluminum nitride, zircon, zircon cordierite, cordierite, low expansion cordierite, aluminum titanate, β-spodumene, and standard porcelain.

Those materials have the linear thermal expansion coefficients described below, for example.
Glass epoxy resin: 21×10⁻⁶/° C. or less
Lossna-Board: 26× 10⁻⁶/° C. or less
Miolex: 23× 10⁻⁶/° C. or less
Besthermo: 40× 10⁻⁶/° C. or less
Polybutylene terephthalate: 15× 10 6/° C. or less
Polyether ether ketone: 25×10⁻⁶/° C. or less
Polyamide imide: 30.6× 10 6/° C. or less
Alumina: 8× 10⁻⁶/° C. or less
Zirconia: 10×10 6/° C. or less
Forsterite: 10×10⁻⁶/° C. or less
Steatite: 8×10⁻⁶/° C. or less
Mullite: 5× 10 6/° C. or less
Aluminum nitride: 5×10 6/° C. or less
Zircon: 4× 10⁻⁶/° C. or less
Zircon cordierite: 4× 10⁻⁶/° C. or less
Cordierite: 3× 10⁻⁶/° C. or less
Low expansion cordierite: 1× 10⁻⁶/° C. or less
Aluminum titanate: 1×10⁻⁶/° C. or less
β-spodumene: 1×10 6/° C. or less
Standard porcelain: 7×10 6/° C. or less

It is to be noted that the linear thermal expansion coefficient of the material configuring each of the first sealing member and the second sealing member is measured by thermomechanical analysis (TMA). For example, the linear thermal expansion coefficient of plastics can be measured based on JIS K 7197 (2012, Testing method for linear thermal expansion coefficient of plastics by thermomechanical analysis), and the linear thermal expansion coefficient of fine ceramics can be measured based on JIS R 1618 (2002, Measuring method of thermal expansion of fine ceramics by thermomechanical analysis).

Examples of the application of the battery according to the embodiment of the present disclosure include power sources for a hybrid electric vehicle (HEV), a plug-in hybrid electric vehicle (PHEV), a battery electric vehicle (BEV), and the like.

What is claimed is:

1. A battery comprising:
an electrode assembly in which a current collector foil, a positive electrode active material layer, and a negative electrode active material layer are stacked, and the current collector foil includes an uncoated portion not coated with the positive electrode active material layer and the negative electrode active material layer in a stacking direction;
a first sealing member having a quadrilateral frame shape, the first sealing member being disposed so as to cover a region of the uncoated portion on an end side of the current collector foil; and
a second sealing member having a quadrilateral frame shape, the second sealing member being disposed so as to cover an outer surface of the first sealing member, wherein
the second sealing member is configured of a material having a linear thermal expansion coefficient of 40×10⁻⁶/° C. or less in at least a region of a corner portion.

2. The battery according to claim 1, wherein the second sealing member is entirely configured of the material having the linear thermal expansion coefficient of 40×10⁻⁶/° C. or less.

3. The battery according to claim 1, wherein the first sealing member is configured of a material having a linear thermal expansion coefficient of 40×10⁻⁶/° C. or less in at least a region of a corner portion.

4. The battery according to claim 3, wherein the first sealing member is entirely configured of the material having the linear thermal expansion coefficient of 40×10⁻⁶/° C. or less.

5. The battery according to claim 1, wherein the material having the linear thermal expansion coefficient of 40×10⁻⁶/° C. or less is at least one type selected from the group consisting of glass epoxy resin, Lossna-Board, Miolex, Besthermo, polybutylene terephthalate, polyether ether ketone, polyamide imide, alumina, zirconia, forsterite, steatite, mullite, aluminum nitride, zircon, zircon cordierite, cordierite, low expansion cordierite, aluminum titanate, β-spodumene, and standard porcelain.
